(19) United States
(12) Patent Application Publication
(10) Pub. No.: US 2013/0031228 A1
(43) Pub. Date: Jan. 31, 2013

(54) SCHEDULED SPLIT TESTING

(71) Applicants: Clifford Patrick Lyon, Melrose, MA (US); Ron Hyman Rothman, Bridgewater, NJ (US)

(72) Inventors: Clifford Patrick Lyon, Melrose, MA (US); Ron Hyman Rothman, Bridgewater, NJ (US)

(73) Assignee: CBS Interactive, Inc., San Francisco, CA (US)

(21) Appl. No.: 13/190,320

(22) Filed: Jul. 25, 2011

(51) Int. Cl. G06F 15/173

(52) U.S. Cl. 709/223

(57) ABSTRACT

A set of enrollment hash slots are allocated to a business unit and are subdivided such that a portion of the enrollment hash slots are allocated to at least one test group. A user ID associated with a user can be hashed using a first hash function to map the user to one of the enrollment hash slots. A set of test hash slots are also subdivided such that a portion of the hash slots are allocated to a test version and a portion of the test hash slots are allocated to a control group. If the user was mapped to a hash slot that is allocated to test in the set of enrollment hash slots, the user ID will again be hashed using a second hash function to map the user to one of the test hash slots.

### BACKGROUND

1. Technical Field

The present disclosure relates to market testing and more specifically to scheduled split testing by assigning user IDs to hash slots.

2. Introduction

Market testing is an important part of almost every consumer-oriented business. In this respect, websites, or Internet-based components of businesses have an advantage in that market testing can be conducted easily, at relatively low cost compared to “real” world focus groups, and the testing can be conducted without the knowledge of the consumer. In most cases these tests evaluate a change in webpage design or content or features.

As with any test, variables should be tightly controlled in order to understand the cause of any variance between test results and historical results. For this reason it is prudent to employ a control group as well as a test group. Such testing wherein a population is divided into one or more test groups and control groups is well known and often referred to as split testing.

Often, when split testing, a tester will choose to only enroll a limited number of users into a test. A determined percentage of users visiting the website are randomly enrolled into a test. Every visitor that is not already enrolled into a test is subject to the random chance of being enrolled into the test. However, such a technique results in a slow increase in the determined percentage of users to be enrolled because un-enrolled users are subject to a chance of enrollment.

To make this concept clear, consider that a test is meant to enroll ten percent of the total 1,000 visitors to a website and the test is to run for one week. As part of the enrollment algorithm, any user that is already enrolled in the test is excluded from the population, but a user that is not enrolled in the test that visits the website multiple times is subjected to the possibility of being selected for the test each time he visits the website. Such double jeopardy for non-enrolled users results in a gradual increase of users enrolled into the test beyond the intended ten percent.

An additional consideration is that prior art split testing techniques often are not suitable for businesses with many different business units. Identification of users that appear in the user populations of multiple business units need to be accounted for in some testing scenarios. The capability to restrict a user to one test within a business unit would offer control against “shadow” or “halo” effects while still allowing multiple business units in the network to enroll the user at the same time. A further consideration is that users making return visits are not treated uniformly on subsequent visits to the website. Such inconsistent treatment can muddy control and test group experiences. Users making return visits should be handled consistently when they return to a website.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for scheduling users into tests. In a preferred embodiment the users are visitors to a website, and the website administrator desires to test how the population of users is likely to react to one or more new features, layouts, or content items, etc. on the website. The website administrator can configure the present technology to schedule a percentage of the total unique users to the website into a test in a fashion that the user is treated consistently upon each trip to the website, and that preconfigures the test to avoid errors that are prone to systems that configure a test as the users arrive to the website.

In one embodiment a first set of hash slots called “enrollment hash slots” are allocated to a business unit. The enrollment hash slots can be subdivided such that a portion of the enrollment hash slots are allocated to at least one test group. When a user navigates to the webpage, a user ID associated with the user can be hashed using a first hash function to map the user to one of the enrollment hash slots.

A second set of hash slots called “test hash slots” are also subdivided such that a portion of the hash slots are allocated to a test variant (other portions can also be allocated to other test variants, if applicable) and a portion of the test hash slots are allocated to a control group. If the user was mapped to a hash slot that is allocated to test in the set of enrollment hash slots, the user ID will again be hashed using a second hash function to map the user to one of the test hash slots.

Users whose user IDs have been mapped to a test variant according to the test hash slots will be exposed to the test page corresponding to that variant of the test while users whose user IDs have been mapped to a control group will be exposed to the control page.

In some embodiments the user's ID can be combined with additional information before being hashed by the one or more hash functions. For example, in an enterprise of many different business units, in some situations it might be desirable to combine the user's ID with a business unit ID which corresponds to the web page the user has accessed the test system through. In these embodiments the user can be recognized as a unique user to the system when accessing the system through different portals, when such is desired.

In some embodiments the first and second hash function can be the same hash function, depending on user needs. Persons of skill in the art will recognize the appropriateness of selecting different hash functions for specific systems.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary method embodiment for setting up a split test;

FIG. 3 illustrates the enrollment hash slots divided into subsets;

FIG. 4 illustrates the test hash slots divided into test groups and a control group;

FIG. 5 illustrates an exemplary method embodiment for scheduling users into split testing groups;

FIG. 6 illustrates an exemplary embodiment of recognizing a return user to a testing system;

FIG. 7 illustrates an exemplary embodiment of assigning a returning user to a hash slot using a previously assigned user ID;

FIG. 8 schematically illustrates a how a hash function assigns a user to a hash slot based on a user ID;

FIG. 9 schematically illustrates how the enrollment hash slots can be used by multiple business group;

FIG. 10 schematically illustrates how a user ID is assigned to a test group and then a test variant or control group by using both hash functions; and

FIG. 11 illustrates how a test management interface (TMI) can be used to configure and run a split test as well as customize and receive testing reports.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

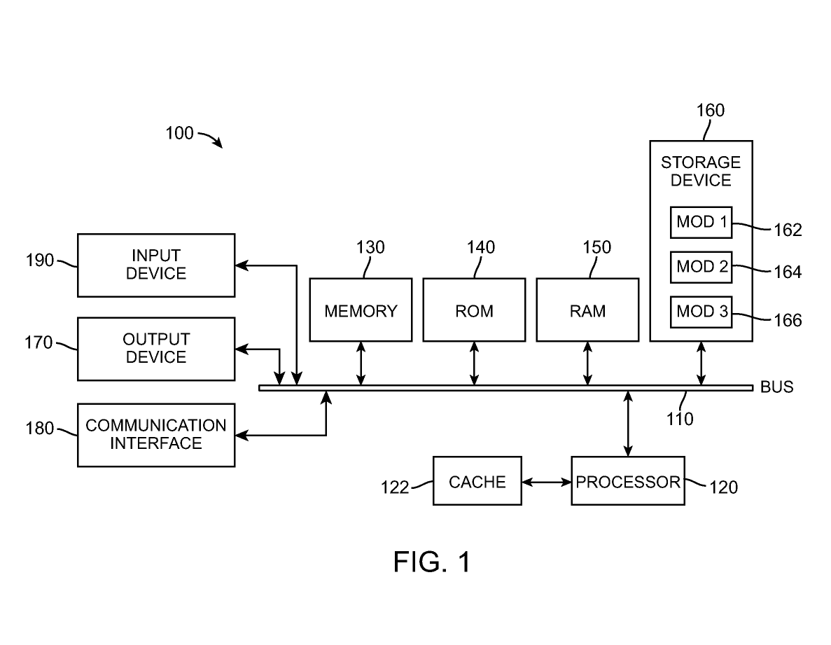

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes a storage device 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, output device 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the storage device 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communication interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors 120 presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules 162, 164, 166 configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

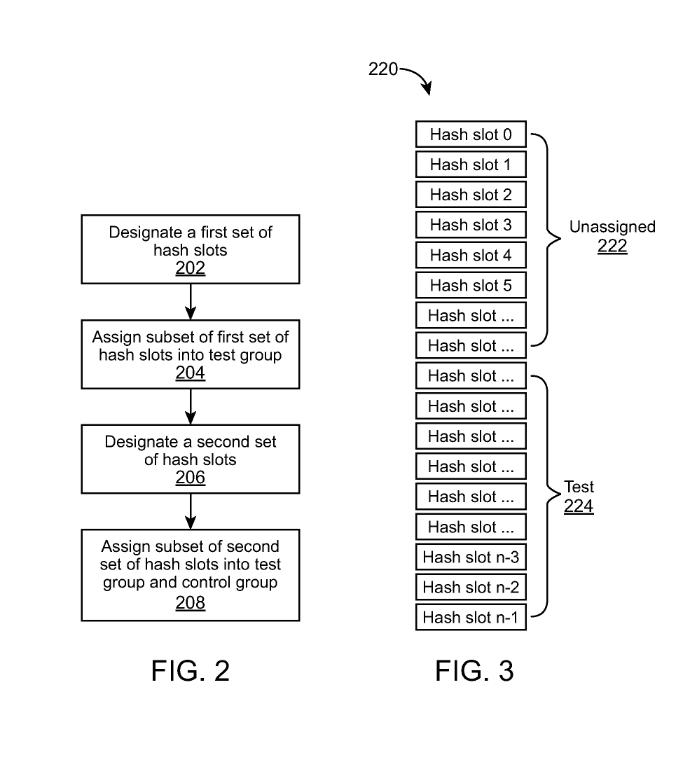

Having disclosed some components of a computing system 100, the disclosure now turns to FIG. 2, which illustrates an exemplary method embodiment for setting up a split test. A website administrator can decide to run a test whereby some users visiting the website can be shown a variant of the website. The variant can be a remodeled page layout, additional content, features, etc. To set up the test, the tester (the site administrator or other entity) can determine that only a limited amount of the site traffic should be subjected to the test. For example, in a site receiving 10,000 unique page views, the tester can determine that 30%, or 3,000 users, should be enrolled in the test.

The present technology sets up the test by designating a first set of hash slots 202 called the “enrollment hash slots”, and assigns a subset of the enrollment hash slots into one or more test groups 204. FIG. 3 graphically illustrates these steps wherein the enrollment hash slots 220 are shown divided into subsets 222 and 224, and subset 224 has been assigned as a test group while subset 222 remains unassigned.

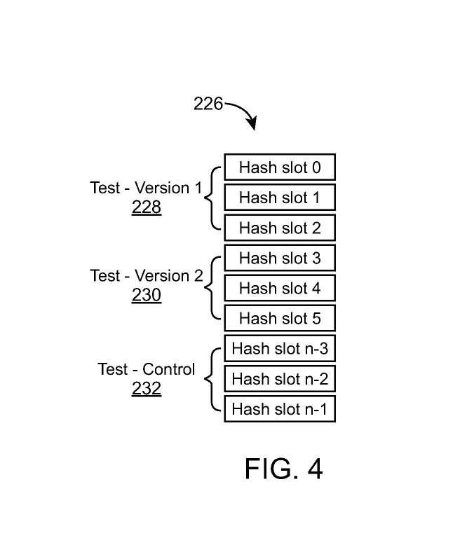

Additionally, a second set of hash slots called “test hash slots” is designated 206, and the test hash slots are divided into subsets assigned into one or more test groups and a control group 208. FIG. 4 illustrates the test hash slots 226 divided into “test group—variant 1” 228, “test group—variant 2” 230, and “test group—control” 232. As will become clear in the following discussion, the users from FIG. 3 assigned to the test group 224 in the enrollment hash slots 220 are hashed into the test hash slots 226 from FIG. 4.

The number of slots designated to the enrollment and test hash slots as well as the number of slots assigned in their corresponding subsets can be configured to test any predetermined percentage of users. Returning to FIG. 3, for example, if a tester wants 30% of users to be enrolled in a test, the tester may designate 1000 hash slots to be the enrollment hash slots 220 and then assign a subset of 300 of those 1000 hash slots to be a test group 224. In this example, the enrollment hash slots 220 may be labeled enrollment hash slots 0-999 (1000 total), the subset left unassigned 222 may include enrollment hash slots 0-699 (700 total) and the subset assigned to the test group 224 may include enrollment hash slots 700-999 (300 total).

This same concept may be used to configure multiple tests variants as shown in FIG. 4. For example, if the tester wants 33% of users to be enrolled in test variant 1 228, 33% to be enrolled in test variant 2 230, and the remaining users to be in the control group 232, the tester may designate 1000 hash slots to the test hash slots 226 and then assign a subset of 333 of those hash slots to test variant1 228, another subset of 333 hash slots to test variant 2 230, and the remaining subset of 334 hash slots to the control group 232. The test hash slots 226 may then be labeled test hash slots 0-999 (1000 total), the subset assigned to test variant 1 228, may then include test hash slots 0-332 (333 total), the subset assigned to test variant 2 230 may then include test hash slots 333-665 (333 total), and the subset assigned to the control group 232 may then include test hash slots 666-999 (334 total).

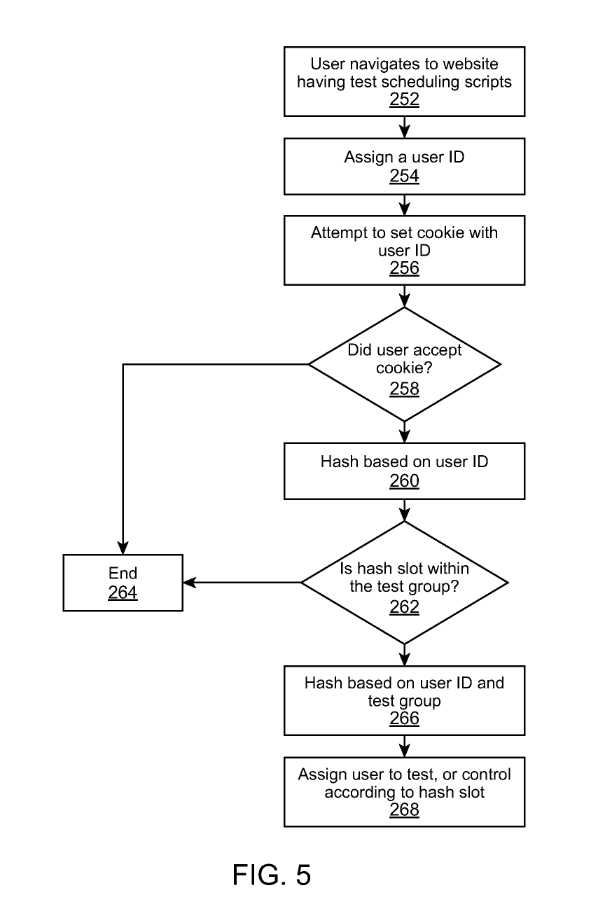

FIG. 5 illustrates an exemplary method embodiment for scheduling users into split testing groups. When a user navigates to a website having test schedule scripts (e.g., JavaScript) installed as part of the page 252, the user can be assigned a user ID 254. The script can attempt to set a third-party cookie containing the user ID 256 on the user's computer. If the user's computer accepts the cookie at 258 then the user is eligible to be enrolled into the test. If the user's computer is configured to not accept the cookie then the user is not eligible to be considered for the test and the method ends 264. If a user is not eligible to be considered for the test then the user may be served a default version of the website.

Assuming the user's browser is configured to accept third party cookies, the user's ID becomes a hash key that is passed to a hash function and ultimately assigned to a hash slot 260 in the enrollment hash slots.

If the resulting hash slot is within the test group 262, the user ID is again passed to a second hash function and assigned to a hash slot in the test hash slots 266. If the user was hashed to a slot in a test variant group, the user will receive the test variant, but if the user was hashed to a slot in a control group, the user will receive the control 268. But, if at 262 the user was found to have been hashed to an enrollment hash slot outside the test group the method ends 264 and the user may receive a default version of the website.

The hash function can be any method of sorting or hashing known to one of skill in the art. However, the specific hash function that is selected preferably should consistently assign users with the same user ID to the same hash slot such that every time an identified user returns to the system the user will be treated consistently in the same fashion as the user was treated in the first visit. It is also preferable if the hash function exhibit the characteristic of random uniformity such that about the same number of users is assigned to each of the hash slots. The hash function may also incorporate a modulus function to ensure that each hash key is assigned to a hash slot within the assigned range. For example, if 10,000 user IDs are hashed, and only 1000 hash slots are assigned, the hash function may apply a modulus operator which divides by the total number of hash slots, in this example 1000, and then returns the remainder to ensure that the user IDs are only hashed to hash slots 0-999. For example, if the user ID inputted into the hash function returned 2,325, the modulus function would divide by 1000 and return the remainder of 325. The user ID would then be assigned to hash slot 325. The modulus operator may be incorporated into the hash function itself or applied to the output of the hash function.

One advantage of the present technology is that a user is treated consistently every time he returns to the website. Since the set of hash slots are pre-assigned into test groups, control groups, or unassigned, as long as the user is consistently matched to the same hash slot his treatment will be the same on return visits. The present technology can also take into account that a user might access the testing system through multiple business units of the same company.

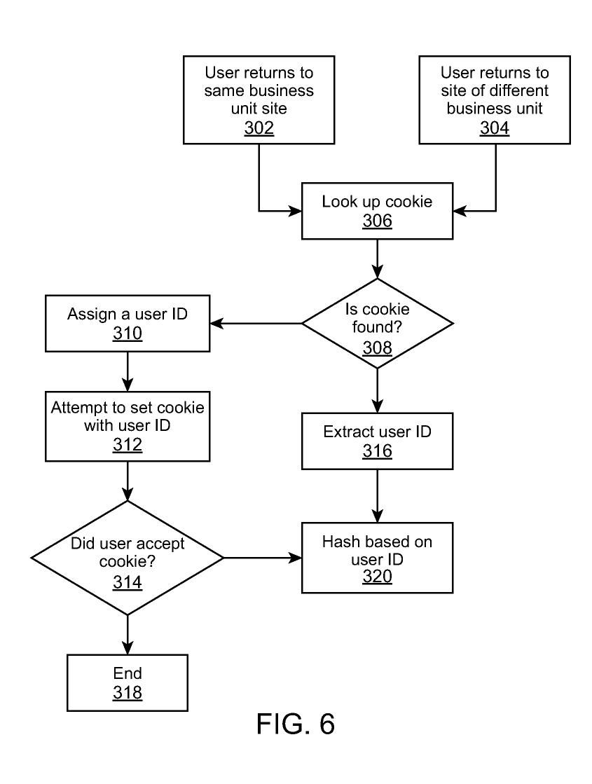

FIG. 6 illustrates an exemplary embodiment of recognizing a return user to a testing system. A user can return to the testing system through the same business unit site he previously visited 302, or through a different business unit 304. Regardless a script running on the webpage attempts to look for a previously stored cookie 306 having a previously assigned user ID. If a cookie is not found 308 the user is treated as a new user and will be assigned a user ID 310, and the script will attempt to set a cookie including the user ID information 312. If the user's computer does not accept cookies 314, the method ends 318, and the user will not be eligible to be enrolled in the test, but if the user's computer does accept the cookie 314, the user's ID will be used by the hashing function to assign a user to a hash slot 320.

For users where a cookie was found upon the initial check 308, the user ID is extracted 316 and used to again hash the user to a hash slot 320. The hash slot to which the user is assigned should be the same hash slot the user was previously assigned to—this should be a characteristic of the hash function employed.

In some embodiments reliable and consistent assignment of a user to a hash slot can be accomplished without using scripts on a webpage and without storing cookies with assigned user IDs. In such embodiments the website can require that a user first sign in using a user account such that the user can be uniquely identified.

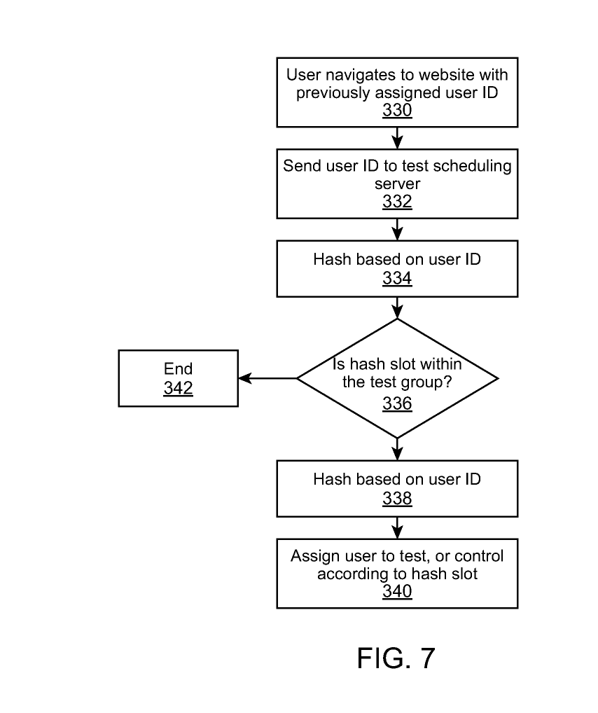

FIG. 7 illustrates an exemplary embodiment of assigning a returning user to a hash slot using a previously assigned user ID. This method works the same whether the user has already been enrolled in and experiencing a test, or when a user logs in to the test for the first time. When the user returns to a website for which he has a previously assigned user ID 330 (the user might be required to enter a user ID and password to authenticate himself and login) a web server can send the user ID to the test server 332. The user's ID can be inputted into a hashing function which can assign a user to an enrollment hash slot based on the user's ID 334. If the enrollment hash slot is within the group of enrollment hash slots assigned to the test group 336, the user ID is again used to hash the user into a test hash slot 338, which results in the user being assigned to a test variant or control group according to the test hash slot to which the user was assigned 340.

If, however, the user was not assigned to a test group based on his assignment to the enrollment hash slot 334, 336, then the user's ID is not hashed again, but rather, the method ends 342.

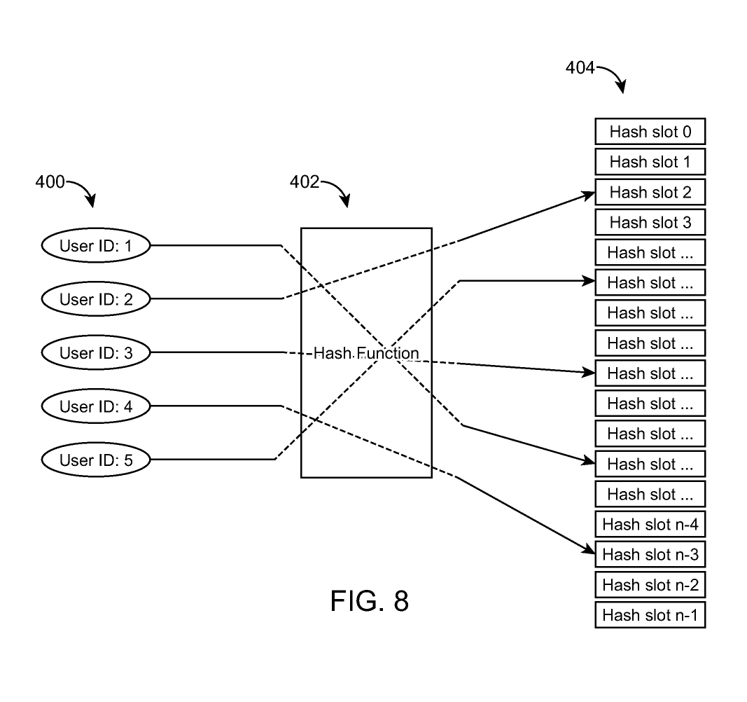

FIG. 8 schematically illustrates how a hash function assigns a user to a hash slot based on a user ID. User IDs 400 are inputted into a hash function 402, which assigns the user to a hash slot 404. In one embodiment, the hash function may output a hash ID that is entered into a modulus function to ensure the output is within the range of hash slots, as described above. In another embodiment the modulus function may be incorporated into the hash function so that the hash function assigns the user to a hash slot.

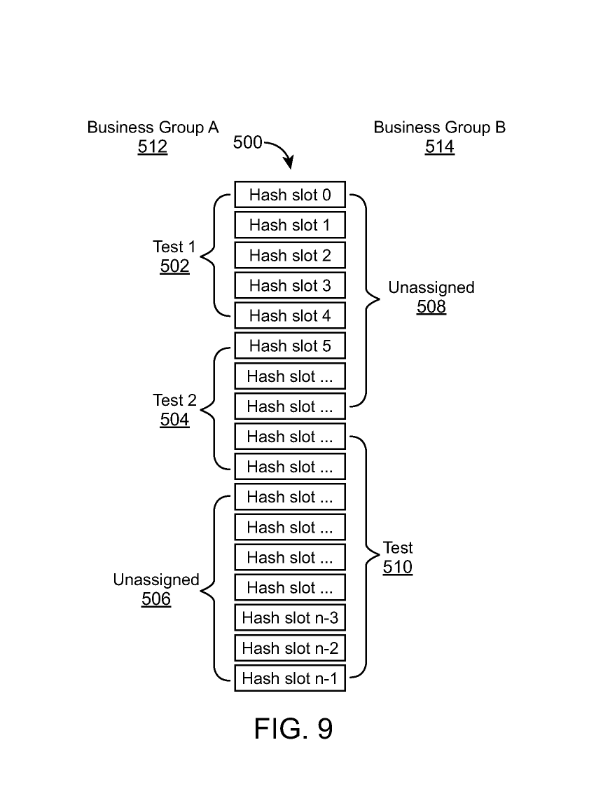

FIG. 9 illustrates how a set of hash slots can be used in an environment with one or more business groups. As illustrated, the enrollment hash slots 500 have been subdivided into one or more test groups, or left unassigned, for two different business units running their own tests. Specifically, Business Group A 512 has subdivided the enrollment hash slots 500 into groups: Test 1 502, Test 2 504, and the rest are unassigned 506. The unassigned population can be in reserve for future tests. Business Group B 514 has assigned a portion of the enrollment hash slots 500 to test 510 and the rest are unassigned 508. When user IDs are hashed into these enrollment hash slots 500, the users associated with each user ID are assigned to the subgroup associated with the hash slot.

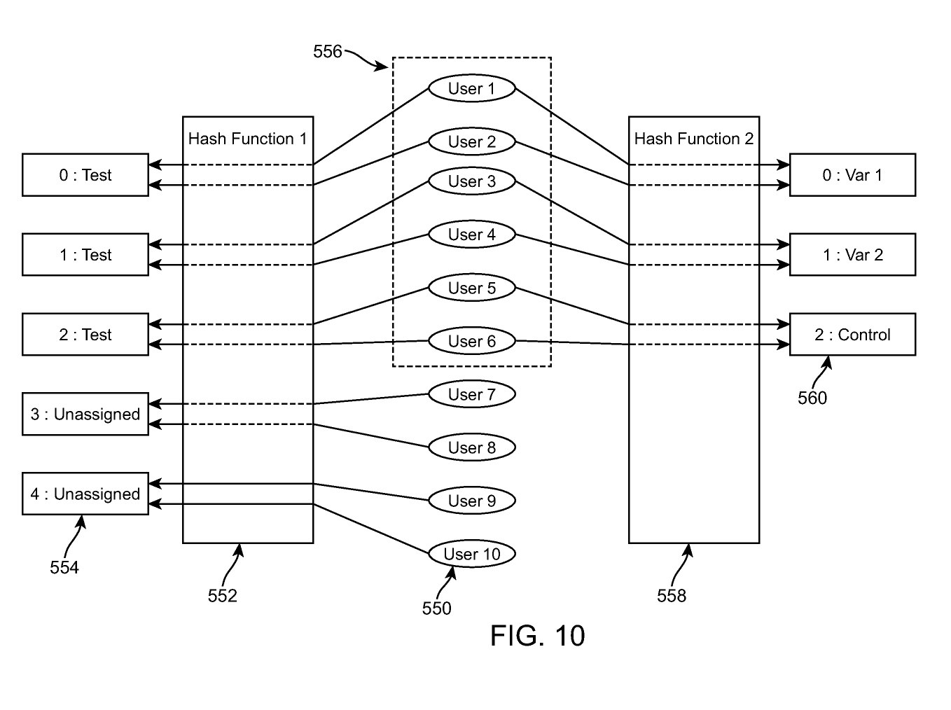

FIG. 10 schematically illustrates how a user ID is assigned to a test group and then a test variant or control group by using both hash functions. The user IDs 550 are inputted into a first hash function 552 which assigns the users to a hash slot in the enrollment hash slots 554. Enrollment hash slots 0-2 have been assigned to be a test group while enrollment hash slots 3 & 4 are unassigned. After entering the user IDs 550 into the first hash function 552, user IDs 1 & 2 are assigned to enrollment hash slot 0, user IDs 3 & 4 are assigned to enrollment hash slot 1, user IDs 5 & 6 are assigned to enrollment hash slot 2, user IDs 7 & 8 are assigned to enrollment hash slot 3, and user IDs 9 & 10 are assigned to enrollment hash slot 4. Since user IDs 1-6 have been assigned to enrollment hash slots 0-3 which are part of the test group, user IDs 1-6 are part of the test group 556. User IDs 7-10 have been assigned to enrollment hash slots 3 & 4 which are unassigned and so User IDs 7-10 are not part of the test. Only user IDs 1-6, which are part of the test group 556, may then be entered into a second hash function 558, which assigns users into a hash slot in the test hash slots 560. Test hash slot 0 is assigned to test variant 1, test hash slot 1 is set to test variant 2, and test hash slot 2 is set to the control group. After entering the user IDs in the test group 556, into the second hash function 558, user IDs 1 & 2 are assigned to test hash slot 0 and thus will be served test variant 1, user IDs 3 &4 are assigned to test hash slot 1 and thus will be served test variant 2, and user IDs 5 & 6 are assigned to test hash slot 2 and are thus part of the control group which can be served the control.

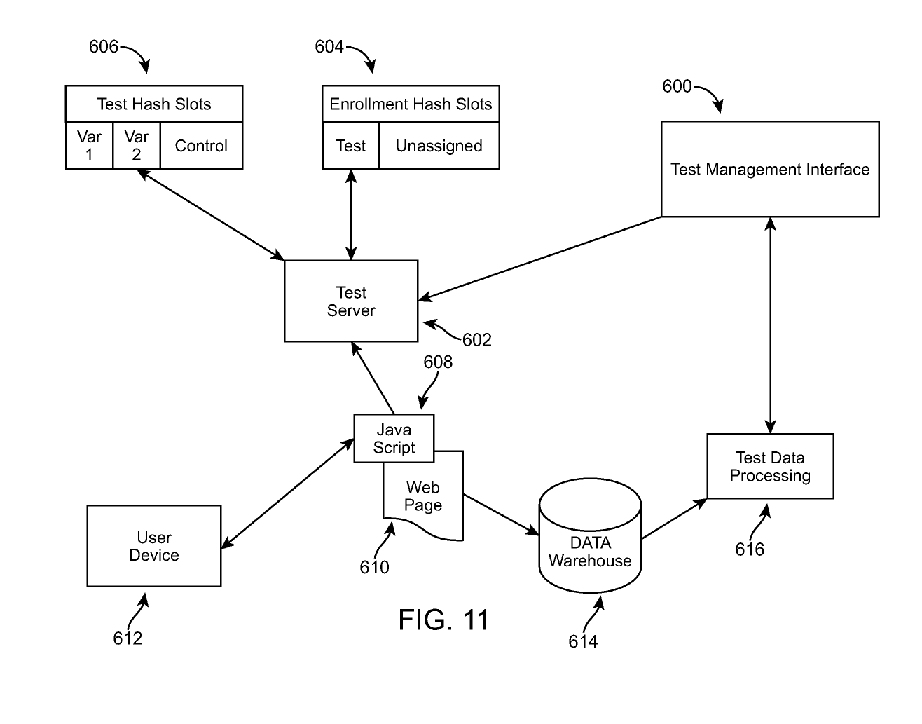

FIG. 11 illustrates how a test management interface (TMI) 600 can be used to configure and run a split test as well as customize and receive testing reports. The TMI 600 can be configured to communicate with a test server 602. The TMI 600 can be running on the test server 602, or from another server and be networked to communicate with the test server 602 by any method known to those skilled in the art. The TMI 600 can be configured to allow a tester to create a test, schedule a test, upload assets, and retrieve code to paste into a webpage, as well as configure and receive reports about the test.

For example, to create a test, a tester may login to the TMI 600 and set test parameters such as test name, begin and end dates, metrics to be recorded, percentage of audience to be tested, number of variants, and percentage of tested users to see each variant or control. A tester may also upload any content to be displayed when a user is served a variant of a webpage.

After receiving test parameters from a tester, the TMI 600 can communicate this data to a test server 602 which is configured to initialize the test. This may include designating the enrollment and test hash slots 604, 606, assigning subsets of each to meet test parameters, and generating any scripts which may be needed to implement the test. The generated scripts can be outputted to the tester to be placed into the web pages to be tested. The script can be any type known by those in the art.

In one embodiment, a java script 608 embedded in a webpage 610 to be tested can be used to communicate between the test server 602 and the user's computer. The java script 608 can be configured to check if a user's device 612 is set to accept cookies, check if a cookie is on the user's device 612, set a cookie on a user's device 612 if allowed, and identify the publisher id (what business unit the user has entered the site from). The java script 608 can also be configured to send a cookie (if one is detected on the user device 612) and publisher id, to the test server 602 and receive a test ID from the test server 602.

The data sent to the test server 602 from the java script 608 is then used to determine whether the user is to be enrolled in the test, and if so, whether the user should be served a test variant or the control. As explained above, if the java script 608 determines that a cookie is already on the user's device 612, the cookie is sent to the test server 602 where the user ID is parsed from the cookie and enters it into the first hash function to be hashed into the enrollment hash slots 604. If the enrollment hash slots 604 have been allocated to multiple business groups as illustrated by FIG. 9, then the publisher id is also sent from the java script 608 to the test server 602 and is entered into the hash function along with the user ID. If no cookie was present on the user's device 612, a user ID is assigned by the test server 602 and entered into the first hash function. Additionally the user ID will be set on the user's device 612 by the java script 608 in the form of a cookie.

If the user ID is hashed into a slot assigned to a test in the enrollment hash slots 604, the user ID is then entered into the second hash function to be assigned to a test hash slot 606. Depending on whether the user ID is hashed into a test hash slot 606 assigned to a test variant or control, the corresponding content is served to the user. A test ID identifying which variant was served is also returned to the java script 608.

Metrics monitoring the user's interaction with the website 610 as well as the test ID are collected at a data warehouse 614. Metrics to be collected can include, but are not limited to, amount of time the user spent on the page, what links were clicked, what business unit the user entered from, the time of day, the day of the week etc. This data is then processed by a test data processing application 616. The test data processing application 616 can be configured by using the TMI 600. The TMI 600 allows a tester to choose what metrics to be viewed and to create reports which may be viewed through the TMI 600.

Using the technology described herein users can be effectively scheduled to participate in a test, and be treated in a consistent manner. The present technology gives the tester greater control over the population selected for the test, thus reducing unanticipated errors and tainting the test candidate pool with other tests.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
designating a subset of enrollment hash slots to a test group;
designating a first subset of test-specific hash slots to a control group, and a second subset of the test-specific hash slots to a test group;
mapping a user to one of the enrollment hash slots by executing a first hash function on a user ID associated with the user, whereby the user is enrolled into the test group when the user ID has mapped to one of the subset of enrollment hash slots that is part of the test group; and
mapping the user, whose user ID has already mapped to an enrollment hash slot that is part of the test group, to one of the test-specific hash slots by executing a second hash function on the user ID associated with the user, whereby the user is determined to be part of a test group or a control group by virtue of being mapped to a test-specific hash slot designated as part of the test group or control group, respectively.

2. The computer-implemented method of claim 1 further comprising:
assigning the user ID to the user upon the first visit to the website.

3. The computer-implemented method of claim 2 further comprising:
setting a third party cookie containing the user ID.

4. The computer-implemented method of claim 1 further comprising:
looking up a third party cookie on the user's machine to see if the user already has a user ID assigned.

5. The computer-implemented method of claim 1 wherein, the user ID is associated with login credentials.

6. The computer-implemented method of claim 1, wherein the first and second hash functions are the same.

7. A system comprising:
a test-server processor;
a first test-server module configured to control the processor to designate a subset of enrollment hash IDs to a test group;
a second test-server module configured to control the processor to designate a first subset of test-specific hash slots to a control group, and a second subset of the test-specific hash slots to a test group;
a third test-server module configured to control the processor to map a user to one of the enrollment hash slots by executing a first hash function on a user ID associated with the user, whereby the user is enrolled into the test group when the user ID has mapped to one of the subset of enrollment hash slots that is part of the test group; and
a fourth test-server module configured to control the processor to map the user, whose user ID has already mapped to an enrollment hash slot that is part of the test group, to one of the test-specific hash slots by executing a second hash function on the user ID associated with the user, whereby the user is determined to be part of a test group or a control group by virtue of being mapped to a test-specific hash slot designated as part of the test group or control group, respectively.

8. The system of claim 0, further comprising:
a web-server processor;
a first web-server module configure to control the processor to select a test version to send to the user based on the user's inclusion in the test group or the control group.

9. The system of claim 8, further comprising
a second web-server module configured to control the web-server processor to assign a user ID to the user.

10. A non-transitory computer-readable storage medium storing instructions which, when executed by a computing device, cause the computing device to perform a method comprising:
designating a subset of enrollment hash slots to a test group;
designating a first subset of test-specific hash slots to a control group, and a second subset of the test-specific hash slots to a test group;
mapping a user to one of the enrollment hash slots by executing a first hash function on a user ID associated with the user, whereby the user is enrolled into the test group when the user ID has mapped to one of the subset of enrollment hash slots that is part of the test group; and
mapping the user, whose user ID has already mapped to an enrollment hash slot that is part of the test group, to one of the test-specific hash slots by executing a second hash function on the user ID associated with the user, whereby the user is determined to be part of a test group or a control group by virtue of being mapped to a test-specific hash slot designated as part of the test group or control group, respectively.

11. The non-transitory computer-readable storage medium of claim 10 further comprising:
assigning the user ID to the user upon the first visit to the website.

12. The non-transitory computer-readable storage medium of claim 11 further comprising:
setting a third party cookie containing the user ID.

13. The non-transitory computer-readable storage medium of claim 10 further comprising:
looking up a third party cookie on the user's machine to see if the user already has a user ID assigned.

14. The non-transitory computer-readable storage medium of claim 10 wherein, the user ID is associated with login credentials.

15. The non-transitory computer-readable storage medium of claim 10, wherein the first and second hash functions are the same.
